(19) United States
(12) Patent Application Publication
(10) Pub. No.: US 2010/0188716 A1
(43) Pub. Date: Jul. 29, 2010

(54) HOLOGRAM RECORDING DEVICE

(75) Inventors: Yasumasa Iwamura, Kawasaki (JP); Hiroyasu Yoshikawa, Kawasaki (JP); Yuzuru Yamakage, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/708,258

(22) Filed: Feb. 18, 2010

Related U.S. Application Data
(63) Continuation of application No. PCT/JP2007/066114, filed on Aug. 20, 2007.

(51) Int. Cl. G03H 1/02

(52) U.S. Cl. 359/3

(57) ABSTRACT

A hologram recording device includes a spatial light modulator having an informational light modulation region modulating part of light from a light source into informational light corresponding to information to be recorded and a reference light emission region emitting the remaining light as reference light, and records a hologram onto a recording medium (B) by causing the informational the reference lights to interfere on the recording medium while the informational and the reference lights are traveling along the same optical path. The hologram recording device includes: a light modulation controller for dividing the informational light modulation region into a plurality of light modulation blocks and controlling a modulation status of the informational light in each light modulation block respectively; and a light emission controller for dividing the reference light emission region into a plurality of light emission blocks and controlling an emission status of the reference light in each light emission block respectively, in conjunction with control of the modulation status in each light modulation block.

This application is a continuation of International Application No. PCT/JP2007/066114, filed on Aug. 20, 2007, the entire contents of which are incorporated herein by reference.

### TECHNICAL FIELD

The present invention relates to a hologram recording device which records a hologram by causing informational light and reference light to interfere on a hologram recording medium, and more particularly, to a hologram recording device of a coaxial type which handles informational light and reference light as a single coaxial light beam.

### BACKGROUND ART

A hologram recording device records a hologram onto a hologram recording medium by forming an interference pattern by causing informational light which has been modulated by a spatial light modulator on the basis of information to be recorded and reference light emitted from the same light source that the informational light is emitted from to interfere on a hologram recording medium. A hologram recording device of a coaxial type such as one described in Patent Document 1 is known as a hologram recording device having a simple optical system. FIG. 9 illustrates a principal structure of a hologram recording device of a coaxial type.

A hologram recording device X performs hologram recording by introducing a light beam emitted from a light source into a spatial light modulator 940 and causing the light beam emitted from the spatial light modulator 940 to converge on a recording layer 102 of a hologram recording medium B by means of an object lens 960. The spatial light modulator 940 includes an informational light modulation region 941 and a reference light emission region 942 formed so as to surround the informational light modulation region 941. The informational light modulation region 941 modulates the introduced light on the basis of information to be recorded, and emits the modulated light as informational light. The reference light emission region 942 emits the introduced light as reference light. The light emitted from the informational light modulation region 941 and the light emitted from the reference light emission region 942 are made to converge at the same position by an object lens 960.

However, in a hologram recording device X of this type, reference lights may be irradiated from two different directions onto the recording layer 102, as indicated by region T illustrated in FIG. 9, and hence an interference pattern may be formed by interference between the respective reference lights. If an interference pattern between the reference lights is formed in this way, then the recording capability of the hologram recording medium B is consumed. Moreover, in the hologram recording device X, since recording is carried out continuously for a prescribed period, then the interference pattern formed in the recording layer 102 may diffract some of the reference light during one recording operation. The reference light diffracted in this way may interfere with other reference light and give rise to an unsuitable continuous interference pattern inside the recording layer 102. During reproduction, an interference pattern which produces light traveling in the same direction as the informational light travels may be mixed into this continuously formed interference pattern. In this case, there is a problem that noise becomes mixed into the reproduction light during reproduction.

Patent Document 1: Japanese Laid-open Patent Publication No. 2006-301465

### DISCLOSURE OF THE INVENTION

### Problems to be Solved by the Invention

The present invention has been proposed under the foregoing circumstances. It is an object of the present invention to provide a hologram recording device capable of preventing consumption of the recording capability of a hologram recording medium, and recording which does not cause noise generation during reproduction.

### Means for Solving the Problems

The hologram recording device provided by a first aspect of the present invention is a hologram recording device, comprising a spatial light modulator having an informational light modulation region which modulates a portion of light from a light source into informational light corresponding to information to be recorded and a reference light emission region which emits a remaining portion of the light as reference light, the hologram recording device recording a hologram onto a recording medium by causing the informational light and the reference light to interfere on the recording medium while the hologram recording device causing the informational light and the reference light to travel along a same optical path, the hologram recording device further comprising light modulation controller for dividing the informational light modulation region into a plurality of light modulation blocks, and controlling a modulation status of the informational light in each of the light modulation blocks.

Preferably, the hologram recording device further comprises light emission controller for dividing the reference light emission region into a plurality of light emission blocks and controlling an emission status of the reference light in each of the light emission blocks, in conjunction with control of the modulation status in each of the light modulation blocks.

Preferably, one of the informational light modulation region and the reference light emission region is formed in a ring shape surrounding an other one of the informational light modulation region and the reference light emission region. The light modulation controller sets the plurality of light modulation blocks sequentially to a modulation-on state, and the light emission controller sets the plurality of light emission blocks sequentially to an emission-on state, in such a manner that each one of the light emission blocks is sequentially set in the emission-on status if corresponding one of the light modulation blocks which is located at an opposite side to the one of the light emission blocks is set in the modulation-on state, so that the one of the light emission blocks is in the emission-on status at a same time as the corresponding one of the light modulation blocks is in the modulation-on status.

Preferably, the light modulation controller divides equivalently the informational light modulation region into the plurality of light modulation blocks, and the light emission controller divides equivalently the reference light emission region into the plurality of light emission blocks, a number of the plurality of light emission blocks being same as a number of the plurality of light modulation blocks.

Preferably, the light emission controller applies a prescribed phase pattern to the reference light, in each of the light emission blocks which is in the emission-on state.

Preferably, the hologram recording device further comprises a reproduction unit for receiving reproduction light produced by irradiating the reference light onto the hologram recording medium and reproducing information based on a recorded hologram, from this reproduction light. During reproduction the light emission controller controls the reference light emission region so as to set the plurality of light emission blocks sequentially to the emission-on state, and the light modulation controller controls the informational light modulation region so as to set all of the light modulation blocks to a modulation-off state.

The hologram recording device provided by a second aspect of the present invention is a hologram recording device, comprising a spatial light modulator which modulates a portion of light from a light source into informational light corresponding to information to be recorded and emits a remaining portion of the light as reference light, the hologram recording device recording a hologram onto a recording medium by causing the informational light and the reference light to interfere on the recording medium while the hologram recording device causes the informational light and the reference light to travel along a same optical path, the hologram recording device further comprising: a polarizer provided between the spatial light modulator and the recording medium and having a reference light polarization region for polarizing the reference light; and polarization controller for dividing the reference light polarization region into a plurality of reference light polarization blocks and polarizing the reference light to a mutually different state of polarization in each of the reference light polarization blocks.

Preferably, the polarizer includes an informational light polarization region which polarizes the informational light. The polarization controller controls the informational light polarization region in such a manner that the informational light is circularly polarized light, and implements control to divide the reference light polarization region into two reference light polarization blocks and to polarize the reference light in mutually perpendicular directions of polarization in each of these two reference light polarization blocks.

Preferably, the polarizer includes an informational light polarization region which polarizes the informational light, and the polarization controller divides equivalently the reference light polarization region into a plurality of reference light polarization blocks, and also divides equivalently the informational light polarization region into a plurality of informational light polarization blocks consisting of a same number of the informational light polarization blocks as a number of the reference light polarization blocks, the polarization controller controlling the plurality of reference light polarization blocks and the plurality of informational light polarization blocks in such a manner that the direction of polarization is same in reference light polarization blocks and informational light polarization blocks which are disposed in mutually symmetrical positions.

### BRIEF DESCRIPTION OF THE DRAWINGS

FIG. 1 is a schematic drawing of a hologram recording device according to a first embodiment of the present invention;

FIG. 2 is a schematic drawing of the principal parts of the hologram recording device in FIG. 1 when carrying out a first recording action;

FIG. 3 is a schematic drawing of the principal parts of the hologram recording device in FIG. 2 when carrying out a second recording action;

FIG. 4 is a plan diagram of a spatial light modulator according to a second embodiment of the present invention;

FIG. 5 is a schematic drawing of a hologram recording device according to a third embodiment of the present invention;

FIG. 6 is a plan diagram of a polarizer in the hologram recording device in FIG. 5;

FIG. 7 is a plan diagram of a polarizer according to a fourth embodiment of the present invention;

FIG. 8 is a plan diagram of a polarizer according to a fifth embodiment of the present invention; and

FIG. 9 is a schematic drawing of the principal part of a conventional hologram recording device.

### BEST MODE FOR CARRYING OUT THE INVENTION

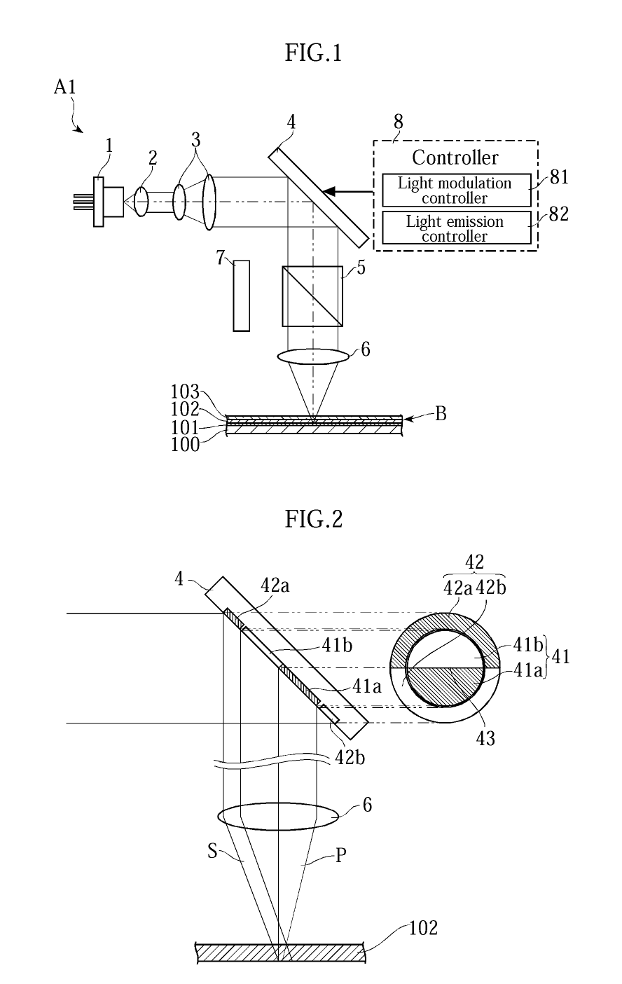

Below, preferred embodiments of the present invention are described in detail with reference to the drawings. FIGS. 1 to 3 illustrate a hologram recording device according to a first embodiment of the present invention.

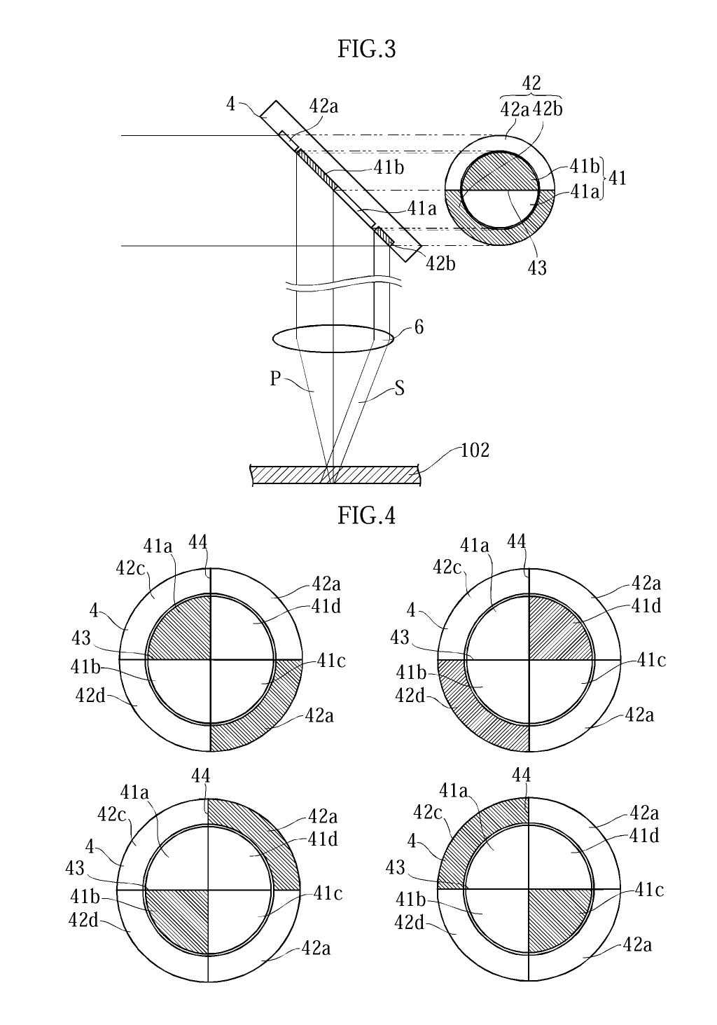

The hologram recording device A1 is a hologram recording device of a collinear type which is capable of recording a hologram by creating an interference pattern through irradiating informational light and reference light onto a hologram recording medium B and reproducing the recorded hologram. The hologram recording device A1 includes a light source 1, a collimating lens 2, a beam expander 3, a spatial light modulator 4, a beam splitter 5, an object lens 6, a reproduction unit 7 and a controller 8. FIG. 2 and FIG. 3 illustrate principal schematic drawings during recording by the hologram recording device A1.

The hologram recording medium B is formed in the shape of a disk and has a structure including, in sequentially laminated fashion, a supporting substrate layer 100, a reflective layer 101, a recording layer 102 and a transparent substrate layer 103. A hologram consisting of an interference pattern is recorded by irradiating informational light and reference light so that they are mutually superimposed on the recording layer 102. The material of the recording layer 102 is an organic material or inorganic material of which the refractive index varies with the light intensity, one example being a light-curable photopolymer. In an initial state of the light-polymerized photopolymer, monomer is dispersed uniformly in a matrix polymer. When light is irradiated onto this polymer, the monomer is polymerized in the exposed portion and the refractive index thereof changes. Since the refractive index of the recording layer 102 changes with the amount of exposure in this way, then it is possible to record the interference pattern produced by interference between informational light P and reference light S, as changes in the refractive index.

The light source 1 is constituted by a semiconductor laser element, for example, and emits laser light having a relatively narrow bandwidth and high coherence. The collimating lens 2 converts the laser light emitted from the light source 1 into parallel light and causes this parallel light to impinge on the beam expander 3. The beam expander 3 is constituted by a combined lens, and expands the diameter of the parallel light and causes this parallel light to impinge on the spatial light modulator 4.

As illustrated in FIG. 2 and FIG. 3, the spatial light modulator 4 includes a circular informational light modulation region 41 which modulates incident light into informational light P in accordance with the information to be recorded, and a ring-shaped reference light emission region 42 surrounding the informational light modulation region 41. The reference light emission region 42 emits reference light S. This spatial light modulator 4 is, for example, constituted of a digital micromirror device in which a plurality of light reflecting elements (not illustrated) are arranged. The light reflecting elements can be switched between an on state where the input light is reflected toward a hologram recording medium B and an off state where the input light is reflected in another direction so that the light does not impinge on the hologram recording medium B. The light reflecting elements in an on state are inclined at a prescribed angle with respect to the light from the light source 1, and cause the light from the light source 1 to impinge on the beam splitter 5.

During recording, the beam splitter 5 transmits the informational light P and the reference light S emitted from the spatial light modulator 4, to the object lens 6. On the other hand, during reproduction, the beam splitter 5 reflects reproduction light emitted from the object lens 6, toward the reproduction unit 7.

During recording, the object lens 6 collects the informational light P and the reference light S onto the recording layer 102, and during reproduction, the object lens 6 emits the reproduction light toward the beam splitter 5.

The reproduction unit 7 is a CCD, for example, and reproduces information on the basis of a recorded hologram, from the received reproduction light.

The controller 8 include light modulation controller 81 which controls the on/off state of the respective light reflecting elements of the informational light modulation region 41, and light emission controller 82 which controls the on/off state of the respective light reflecting elements of the reference light emission region 42.

The light modulation controller 81 controls the modulation status of the informational light in each light modulation block 41a and 41b, into which the informal light modulation region 41 is equally divided. The light emission controller 82 controls the emission status of the reference light in each light emission block 42a and 42b, into which the reference light emission region 42 is equally divided. A common straight line 43 divides the light modulation blocks 41a and 41b and also divides the light emission blocks 42a and 42b. The light modulation block 41a and the light emission block 42a are disposed on opposite sides of the common straight line 43, and the light modulation block 41b and the light emission block 42b are disposed on opposite sides of the common straight line 43. The light modulation controller 81 is able to switch between the modulation on state and modulation off state, by controlling the on/off state of the respective light reflecting elements in each of the light modulation blocks 41a and 41b. The light modulation blocks 41a and 41b modulate light from the light source 1 to emit it as informational light P when the modulation state is on, and shut off the light from the light source 1 not to emit informational light P when the modulation state is off. The light emission controller 82 is able to switch between the emission on state and emission off state, by controlling the on/off state of the respective light reflecting elements in each of the light emission blocks 42a and 42b. The light emission blocks 42a and 42b emit light from the light source 1 as reference light S when the emission state is on, and shut off the light from the light source 1 not to emit reference light S when the emission state is off. In FIG. 2 and FIG. 3, the blocks in the modulation-on state and emission-on state are depicted by hatching.

Next, the operation of the hologram recording device A1 will be described.

During recording, firstly, as illustrated in FIG. 2, the hologram recording device A1 sets the light modulation block 41a to the modulation-on state as well as setting the light emission block 42a to the emission-on state, and carries out a first hologram recording action. In this case, the controller 8 implements control to set the light modulation block 41b to the modulation-off state and to set the light emission block 42b to the emission-off state. The informational light emitted from the light modulation block 41a and the reference light emitted from the light emission block 42a are collected onto the recording layer 102 by the object lens 6 and thereby form an interference pattern.

Thereupon, as illustrated in FIG. 3, the hologram recording device A1 sets the light modulation block 41b to the modulation-on state as well as setting the light emission block 42b to an emission-on state, and carries out a second hologram recording action. In this case, the controller 8 implements control to set the light modulation block 41a to the modulation-off state and to set the light emission block 42a to the emission-off state. The informational light P emitted from the light modulation block 41b and the reference light S emitted from the light emission block 42b are collected onto the recording layer 102 by the object lens 6 and thereby form an interference pattern. In this way, the hologram recording device A1 is able to record the information that has been displayed the informational light modulation region 41 on the basis of the information to be recorded, onto the recording layer 102. It is also possible to reverse the order of the first recording action and the second recording action.

On the other hand, during reproduction, the hologram recording device A1 sets both of the light modulation blocks 41a and 41b to the modulation-off state, and sets the light emission blocks 42a and 42b sequentially to the emission-on state, to reproduce the hologram. In this case, the light emission controller 82 implements control in such a manner that if one of the light emission blocks 42a and 42b is in the emission-on state, then the other one of the light emission blocks is in the emission-off state. Either of the light emission blocks 42a and 42b may be set to the emission-on state first.

Next, the action of the hologram recording device A1 will be described.

The hologram recording device A1 divides each of the informational light modulation region 41 and the reference light emission region 42 into two portions, and during a first recording action, the informational light and the reference light emitted from the light modulation block 41a and the light emission block 42a, which are located on opposite sides, are made to interfere. During the second recording action, the informational light and the reference light emitted from the light modulation block 41b and the light emission block 42b, which are located on opposite sides, are made to interfere. In the hologram recording device A1 described above, in either the first or second recording actions, the informational light P is not emitted simultaneously from the light modulation blocks 41a and 41b located at symmetrical positions, and therefore it is possible to reduce the interference pattern between respective informational lights P drastically compared to a conventional device. Similarly, in the hologram recording device A1, the reference light S is not emitted simultaneously from the light emission blocks 41a and 41b which are located at symmetrical positions, and therefore it is possible to reduce the interference pattern between reference lights S drastically compared to a conventional device. Consequently, the hologram recording device A1 is able to suppress formation of an interference pattern other than the interference pattern based on the information to be recorded. By suppressing formation of an interference pattern of this kind, it is possible to prevent consumption of the monomer due to wasteful polymerization of the monomer in the recording layer 102.

Moreover, in the hologram recording device A1, during reproduction, since the light emission blocks 42a and 42b do not emit the reference light S simultaneously, then an interference pattern is prevented from being formed in the recording layer 102. Therefore, it is possible to prevent further consumption of the monomer in the recording layer 102.

Furthermore, in the hologram recording device A1, since the interference between reference lights and the interference between informational lights are suppressed, then it is possible to reduce formation of an interference pattern which emits light traveling in the same direction as the reproduction light travels, compared to a conventional device. Consequently, the hologram recording device A1 is able to carry out recording and reproduction with less noise generation compared to a conventional device.

Moreover, in the hologram recording device A1, an interference pattern is generated due to interference occurring between the informational light P and the reference light S emitted from blocks located on opposite sides. Therefore, the angle of intersection between the informational light P and the reference light S is made larger, and the spatial resolution of the interference pattern generated by interference between the informational light P and the reference light S tends to increase.

FIG. 4 illustrates a plan diagram of a spatial light modulator in a hologram recording device according to a second embodiment of the present invention. The hologram recording device in this embodiment has a similar composition to that of the hologram recording device A1. However, in this embodiment, during recording, the controller 8 implements control to divide each of the informational light modulation region 41 and the reference light emission region 42 into four portions.

In this embodiment, the light modulation controller 81 implements control to divide the informational light modulation region 41 into four equivalent portions to create light modulation blocks 41a, 41b, 41c and 41d, and to switch between the modulation on state and modulation off state respectively in each of the light modulation blocks 41a, 41b, 41c and 41d. The light emission controller 82 implements control to divide the reference light emission region 42 into four equivalent portions to create light emission blocks 42a, 42b, 42c and 42d, and to switch between the emission on state and emission off state in each of the light emission blocks 42a, 42b, 42c and 42d, respectively. As illustrated in FIG. 4, the two common straight lines 43 and 44 divide the light modulation blocks 41a, 41b, 41c and 41d, and also divide the light emission blocks 42a, 42b, 42c and 42d. The light modulation block 41a and the light emission block 42a are disposed at opposite sides of the point of intersection of the two common straight lines 43 and 44. The light modulation blocks 41b, 41c and 41d and the light emission blocks 42b, 42c and 42d are disposed at opposite sides of this point of intersection, respectively.

In the hologram recording device, the information displayed on the informational light modulation region 41 is recorded through four recording actions. Firstly, in a first recording action, the controller 8 sets the light modulation block 41a to the modulation-on state to emit informational light therefrom, and sets the light emission block 42a to the emission-on state to emit reference light therefrom. In this case, the controller 8 sets the light modulation blocks 41b, 41c and 41d to the modulation-off state, and the light emission blocks 42b, 42c and 42d to the emission-off state. In a second recording action, the controller 8 sets the light modulation block 41b to the modulation-on state to emit informational light therefrom, and sets the light emission block 42b to the emission-on state to emit reference light therefrom. In this case, the controller 8 sets the light modulation blocks 41a, 41c and 41d to the modulation-off state, and the light emission blocks 42a, 42c and 42d to the emission-off state. In a third recording action, the controller 8 sets the light modulation block 41c to the modulation-on state to emit informational light therefrom, and sets the light emission block 42c to the emission-on state to emit reference light therefrom. In this case, the controller 8 sets the light modulation blocks 41a, 41b and 41d to the modulation-off state, and the light emission blocks 42a, 42b and 42d to the emission-off state. In a fourth recording action, the controller 8 sets the light modulation block 41d to the modulation-on state to emit informational light therefrom, and sets the light emission block 42d to the emission-on state to emit reference light therefrom. In this case, the controller 8 sets the light modulation blocks 41a, 41b and 41c to the modulation-off state, and the light emission blocks 42a, 42b and 42c to the emission-off state. FIG. 4 illustrates a plan diagram of a spatial light modulator 5 from the first to the fourth recording actions, and blocks which are in the modulation-on state or emission-on state are indicated by hatching. The order of the first to fourth recording actions may be changed.

By recording a hologram by dividing each of the informational light modulation region 41 and the reference light emission region 42 into four portions in this way, interference between respective reference lights and interference between respective informational lights become more unlikely to occur than the case where recording is carried out by dividing each of the above-described regions into two portions. Consequently, the hologram recording device of this type is able to prevent consumption of the monomer in the recording layer 102 more effectively than the hologram recording device A1. Moreover, since the interference between respective reference lights and the interference between respective informational lights are suppressed more effectively than the hologram recording device A, then it is possible to reduce formation of an interference pattern which emits light in the same direction as the reproduction light travels, compared to a conventional device. Therefore, this hologram recording device is able to carry out recording and reproduction with less noise generation than the hologram recording device A1.

In the first and second embodiments described above, the reference light is not modulated in a similar way as the informational light is, but it is also possible to carry out recording based on a phase code multiplexing method by giving a phase pattern to the reference light. Hologram recording based on a phase code multiplexing method can be achieved by performing control in which each light emission block in the emission-on state applies a prescribed phase pattern to the reference light by the light emission controller 82. By adopting this control, it is possible to record holograms in a multiplexed fashion at the same position of the recording layer 102, and it is possible to record a larger amount of information on the hologram recording medium B.

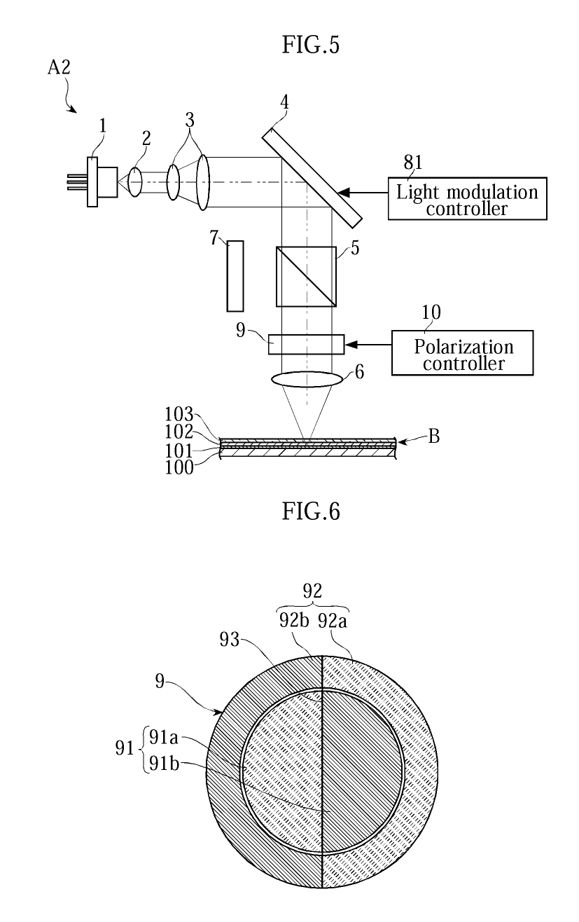

FIG. 5 illustrates a structure of a hologram recording device A2 according to a third embodiment of the present invention. In FIG. 5, constituent elements which are the same as the hologram recording device A1 are labeled with the same reference numerals and further description thereof is omitted. The description given below centers on the points of difference between the hologram recording device A2 and the hologram recording device A1. Although not illustrated in FIG. 5, the spatial light modulator 4 in the hologram recording device A2 includes an informational light modulation region 41 and a reference light emission region 42, similarly to the hologram recording device A1.

The hologram recording device A2 includes a polarizer 9 and modulation controller 10 for controlling the polarizer 9, in addition to the structure of the hologram recording device A1. However, in contrast to the hologram recording device A1, in the hologram recording device A2, the informational light and the reference light are not divided by the spatial light modulator 4, and therefore the light emission controller 82 as provided in the hologram recording device A1 is not provided. Furthermore, in the light modulation controller 81 in the hologram recording device A2, control is implemented so as to modulate the light from the light source 1 into informational light, in the informational light modulation region 41, without dividing up the informational light modulation region 41.

The polarizer 9 is provided between the beam splitter 5 and the object lens 6 on the light path of the informational light and the reference light, and is able to adjust the direction of polarization of the informational light and the reference light. FIG. 6 is a plan diagram illustrating the polarizer 9 in a plane perpendicular to the informational light and the reference light. As illustrated in FIG. 6, the polarizer 9 includes an informational light polarization region 91 which adjusts the direction of polarization of the informational light and a reference light polarization region which adjusts the direction of polarization of the reference light. For example, it is possible to use a photo-elastic modulator as the polarizer 9.

The polarization controller 10 divides the informational light polarization region 91 into two equivalent portions, i.e. informational light polarization blocks 91a and 91b, and controls the polarization status of the informational light in each informational light polarization block 91a and 91b. The polarization controller 10 also divides the reference light polarization region 92 into two equivalent portions, i.e. reference light polarization blocks 92a and 92b, and controls the polarization status of the informational light in each reference light polarization block 92a and 92b. In this case, a common straight line 93 divides the informational light polarization blocks 91a and 91b, and also divides the reference light polarization blocks 92a and 92b. The informational light polarization block 91a and the reference light polarization block 92a are disposed at symmetrical positions with respect to the common straight line 93. In a similar fashion, the informational light polarization block 91b and the reference light polarization block 92b are disposed at symmetrical positions with respect to the common straight line 93. The polarization controller 10 controls the informational light polarization blocks 91a and 91b in such a manner that the direction of polarization of the informational light in the informational light polarization block 91a and the direction of polarization of the informational light in the informational light polarization block 91b are mutually perpendicular. At the same time, the polarization controller 10 controls the reference light polarization blocks 92a and 92b in such a manner that the direction of polarization of the informal light at informational light polarization blocks 91a and 91b coincide with the direction of polarization of the informal light at informational light polarization blocks 92a and 92b, respectively.

In the hologram recording device A2 of this kind, the informational lights emitted by the informational light polarization blocks 91a and 91b have mutually different directions of polarization, and therefore do not interfere with each other. Similarly, there is no mutual interference between the reference lights which are emitted from the reference light polarization blocks 92a and 92b. Therefore, similarly to the hologram recording device A1, the hologram recording device A2 is able to suppress formation of an interference pattern due to interference between the informational lights and interference between the reference lights. Consequently, in the hologram recording device A2, it is possible to suppress consumption of monomer in the recording layer 102. Moreover, in the hologram recording device A2, since interference between the reference lights and interference between the informational lights are suppressed, then it is possible to reduce formation of an interference pattern which emits light in the same direction as the reproduction light travels, and recording and reproduction with less noise generation can be achieved, compared to a conventional device.

Furthermore, in the hologram recording device A2, in contrast to the hologram recording device A1, it is possible to record the information displayed on the informational light modulation region 41, in one recording action. Therefore, the recording speed can be raised in comparison with the hologram recording device A1.

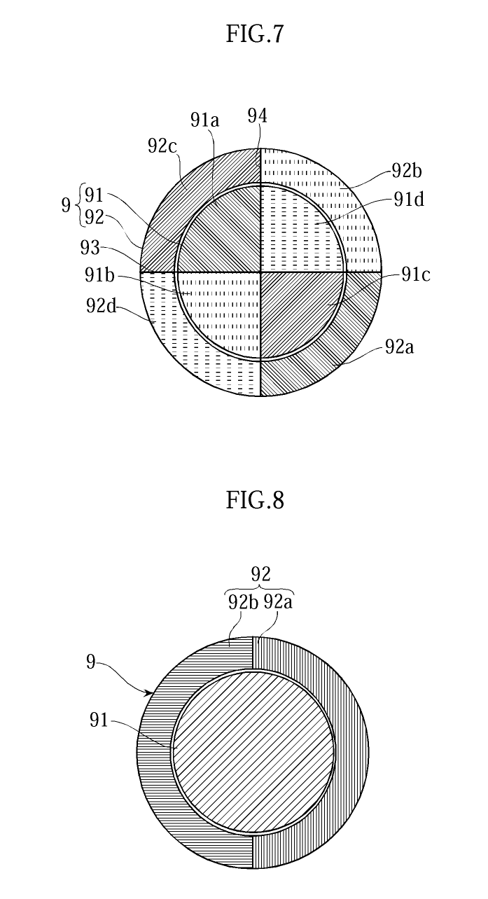

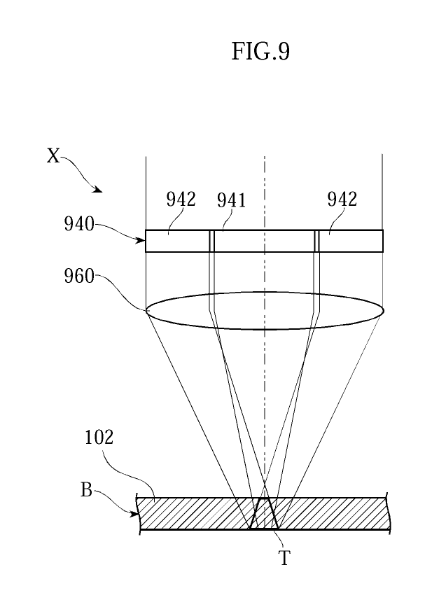

FIG. 7 is a plan view of a polarizer of a hologram recording device according to a fourth embodiment of the present invention. This hologram recording device has a similar structure to that of the hologram recording device A2. In this embodiment, the polarization controller 10 divides each of the informational light polarization region 91 and the reference light polarization region 92 into four portions for control.

The polarization controller 10 divides the informational light polarization region into four equivalent portions to create informational light polarization blocks 91a, 91b, 91c and 91d, and controls the directions of polarization of the informational light to be oriented in mutually different directions in the informational light polarization blocks 91a, 91b, 91c and 91d. At the same time, the polarization controller 10 divides the reference light polarization region 92 into four equivalent portions to create reference light polarization blocks 92a, 92b, 92c and 92d, and controls the directions of polarization of the reference light to be oriented in mutually different directions in the reference light polarization blocks 92a, 92b, 92c and 92d. As illustrated in FIG. 7, the two common straight lines 93 and 94 divide the informational light polarization blocks 91a, 91b, 91c and 91d, and also divide the reference light polarization blocks 92a, 92b, 92c and 92d. The polarization controller 10 implements control in such a manner that the informational light polarization block 91a and the reference light polarization block 92a are disposed at opposite sides of the point of intersection of these two common straight lines 93 and 94. At the same time, the polarization controller 10 implements control in such a manner that the informational light polarization blocks 91b, 91c and 91d and the reference light polarization blocks 92b, 92c and 92d are disposed at opposite sides of the same intersection point.

Furthermore, the polarization controller 10 controls the reference light polarization block 92a in such a manner that the direction of polarization of the reference light at the reference light polarization block 92a coincides with the direction of polarization of the informational light at the informational light polarization block 91a. At the same time, the polarization controller 10 controls the reference light polarization blocks 92b, 92c and 92d in such a manner that the directions of polarization of the reference light at the reference light polarization blocks 92b, 92c and 92d coincide with the directions of polarization of the informational light at the informational light polarization blocks 91b, 91c and 91d, respectively. In FIG. 7, blocks which polarize the informational light or the reference light in the same direction are indicated with the same hatching pattern. The polarization controller 10 also implements control in such a manner that the directions of polarization of the informational light at the informational light polarization blocks 91a and 91c are mutually perpendicular. Similarly, the polarization controller 10 also implements control in such a manner that the directions of polarization of the informational light by the informational light polarization blocks 91b and 91d are mutually perpendicular.

In the hologram recording device of this type, the informational lights emitted by the informational light polarization blocks 91a, 91b, 91c and 91d have mutually different directions of polarization, and therefore do not interfere with each other. Similarly, there is no mutual interference between the reference lights which are emitted from the reference light polarization blocks 92a, 92b, 92c and 92d. In particular, since the directions of polarization of the informational lights and the reference lights which are emitted from symmetrical positions are perpendicular, then interference does not occur. This hologram recording device divides each of the informational light and the reference light into four portions each of which corresponds to a direction of polarization, and therefore it is possible to accomplish better suppression of the occurrence of an interference pattern due to interference between informational lights and interference between the reference lights than the hologram recording device A2. Consequently, it is possible to suppress consumption of monomer in the recording layer 102 more effectively than in the hologram recording device A2. Moreover, since an interference pattern caused by interference of reference lights and interference of informational lights is prevented from being formed, then it is possible to reduce formation of an interference pattern which emits light in the same direction as the reproduction light travels, and recording and reproduction with less noise generation can be achieved, compared to a conventional device.

FIG. 8 is a plan view of a polarizer of a hologram recording device according to a fifth embodiment of the present invention. This hologram recording device has a similar structure to that of the hologram recording device A2. In this embodiment, the polarization controller 10 implements control to divide the reference light polarization region 92 into two portions, without dividing the informational light polarization region 91.

In this embodiment, the polarization controller 10 controls the informational light polarization region 91 in such a manner that the informational light polarization region 91 emits the informational light as circularly polarized light. At the same time, the polarization controller 10 divides the reference light polarization region into two equivalent portions, i.e. reference light polarization blocks 92a and 92b, and implements control to polarize the reference light in mutually perpendicular directions, in reference light polarization blocks 92a and 92b.

By means of this hologram recording device, it is possible to prevent the reference lights emitted from the reference light polarization blocks 92a and 92b from interfering with each other and also prevent an interference pattern from being formed on the recording layer 102. Therefore, it is possible to suppress consumption of the monomer in the recording layer 102. Moreover, since interference of reference lights is suppressed, then it is possible to reduce formation of an interference pattern which emits light in the same direction as the reproduction light travels, and recording and reproduction with less noise generation can be achieved, compared to a conventional device.

The scope of the present invention is not limited to the embodiments described above and also includes any variations within the scope of the claims. For example, in the present embodiment, a digital micromirror device is used as the spatial light modulator 4, but it is also possible to use a liquid crystal display apparatus. Furthermore, in the embodiment described above, the reference light emission region 42 is formed so as to surround the informational light modulation region 41, but the disposition of these regions may be reversed. Furthermore, in the hologram recording device A2, it is possible to use a liquid crystal apparatus, or a component consisting of combined small pieces of polarizing plate, as the polarizer 9.

1. A hologram recording device, comprising a spatial light modulator that includes an informational light modulation region which modulates a portion of light from a light source into informational light corresponding to information to be recorded and a reference light emission region which emits a remaining portion of the light as reference light, the hologram recording device recording a hologram onto a recording medium by causing the informational light and the reference light to interfere on the recording medium while the hologram recording device causing the informational light and the reference light to travel along a same optical path,
the hologram recording device further comprising a light modulation controller for dividing the informational light modulation region into a plurality of light modulation blocks, and controlling a modulation status of the informational light in each of the light modulation blocks.

2. The hologram recording device according to claim 1, further comprising a light emission controller for dividing the reference light emission region into a plurality of light emission blocks and controlling an emission status of the reference light in each of the light emission blocks, in conjunction with control of the modulation status in each of the light modulation blocks.

3. The hologram recording device according to claim 2,
wherein one of the informational light modulation region and the reference light emission region is formed in a ring shape surrounding an other one of the informational light modulation region and the reference light emission region; and
wherein the light modulation controller sets the plurality of light modulation blocks sequentially to a modulation-on state, and the light emission controller sets the plurality of light emission blocks sequentially to an emission-on state, in such a manner that each one of the light emission blocks is sequentially set in the emission-on status if corresponding one of the light modulation blocks which is located at an opposite side to the one of the light emission blocks is set in the modulation-on state, so that the one of the light emission blocks is in the emission-on status at a same time as the corresponding one of the light modulation blocks is in the modulation-on status.

4. The hologram recording device according to claim 3, wherein the light modulation controller divides equivalently the informational light modulation region into the plurality of light modulation blocks, and the light emission controller divides equivalently the reference light emission region into the plurality of light emission blocks, a number of the plurality of light emission blocks being same as a number of the plurality of light modulation blocks.

5. The hologram recording device according to claim 3 or 4, wherein the light emission controller applies a prescribed phase pattern to the reference light, in each of the light emission blocks which is in the emission-on state.

6. The hologram recording device according to claim 3 or 4, further comprising a reproduction unit for receiving reproduction light produced by irradiating the reference light onto the hologram recording medium and reproducing information based on a recorded hologram, from this reproduction light,
wherein during reproduction the light emission controller controls the reference light emission region so as to set the plurality of light emission blocks sequentially to the emission-on state, and the light modulation controller controls the informational light modulation region so as to set all of the light modulation blocks to a modulation-off state.

7. A hologram recording device, comprising a spatial light modulator which modulates a portion of light from a light source into informational light corresponding to information to be recorded and emits a remaining portion of the light as reference light, the hologram recording device recording a hologram onto a recording medium by causing the informational light and the reference light to interfere on the recording medium while the hologram recording device causes the informational light and the reference light to travel along a same optical path,
the hologram recording device further comprising:
a polarizer provided between the spatial light modulator and the recording medium and having a reference light polarization region for polarizing the reference light; and
a polarization controller for dividing the reference light polarization region into a plurality of reference light polarization blocks and polarizing the reference light to a mutually different state of polarization in each of the reference light polarization blocks.

8. The hologram recording device according to claim 7,
wherein the polarizer includes an informational light polarization region which polarizes the informational light, and
wherein the polarization controller controls the informational light polarization region in such a manner that the informational light is circularly polarized light, and implements control to divide the reference light polarization region into two reference light polarization blocks and to polarize the reference light in mutually perpendicular directions of polarization in each of these two reference light polarization blocks.

9. The hologram recording device according to claim 7, wherein the polarizer includes an informational light polarization region which polarizes the informational light, and the polarization controller divides equivalently the reference light polarization region into a plurality of reference light polarization blocks, and also divides equivalently the informational light polarization region into a plurality of informational light polarization blocks consisting of a same number of the informational light polarization blocks as a number of the reference light polarization blocks, the polarization controller controlling the plurality of reference light polarization blocks and the plurality of informational light polarization blocks in such a manner that the direction of polarization is same in reference light polarization blocks and informational light polarization blocks which are disposed in mutually symmetrical positions.
